(19) United States
(12) Patent Application Publication
(10) Pub. No.: US 2015/0264749 A1
(43) Pub. Date: Sep. 17, 2015

(54) ADHESIVE RADIANT HEATING

(71) Applicant: F6 Solutions, LLC, San Diego, CA (US)

(72) Inventor: Timothy Schettler, Aurora, CO (US)

(73) Assignee: F6 Solutions, LLC, San Diego, CA (US)

(21) Appl. No.: 14/217,445

(22) Filed: Mar. 17, 2014

(51) Int. Cl. H05B 3/18; B32B 37/26; B32B 37/12

(52) U.S. Cl. CPC H05B 3/18; B32B 37/12; B32B 37/26; B32B 2037/268; B32B 2419/04

(57) ABSTRACT

A radiant heating element is described. The radiant heating element includes: a top layer; a resistive element coupled to the top layer; a conducting element coupled to the resistive layer and the top layer; and a bottom layer coupled to the resistive layer and the conducting element. A peel and stick adhesive radiant floor heating element includes: a top surface; a thermo-resistive element coupled to the top surface and adapted to generate heat in response to an applied voltage; and an adhesive layer coupled to the thermo-resistive element. A method of installing radiant floor heating using a peel and stick adhesive radiant floor heating element is described. The method includes: removing a release liner from an adhesive surface of the heating element; and securing the heating element to a sub-surface.

### BACKGROUND OF THE INVENTION

Many building applications require the installation of radiant heating (e.g., radiant floor heating). Such radiant heating may typically be secured to a sub-surface using various adhesives or connectors that must be applied at the time of installation. Existing materials may not be optimized to allow installers to be able to arbitrarily manipulate the heating elements at the installation location (e.g., by trimming the elements, cutting ports to fit around obstacles, etc.), instead requiring any modifications to be performed at the manufacturing facility. In addition, existing solutions may require installation of additional layers (e.g., bonding surfaces) in order to cover the radiant heating with finish materials (e.g., flooring).

Thus there is a need for a peel and stick radiant heating element that may be manipulated at the time of installation and allows for bonding of finish layers.

### BRIEF SUMMARY OF THE INVENTION

Some embodiments of the invention may provide a radiant heating element. The element may include an adhesive surface that is adapted to allow the element to be secured to a sub-surface (e.g., a sub-floor). The element may include geotextile or other suitable surface material that allows for the direct application of thin set mortar and/or other adhesive and/or bonding materials. The radiant heating element may include a heat generating sub-element that may be formed as a planar sheet. The geotextile or other surface material(s) may be integrated with the heat generating sub-element. The radiant heating element may be able to be manipulated in various arbitrary ways (e.g., by trimming the element, by cutting ports into the element, etc.).

A first exemplary embodiment of the invention provides a radiant heating element that includes: a top layer; a resistive element coupled to the top layer; a conducting element coupled to the resistive layer and the top layer; and a bottom layer coupled to the resistive layer and the conducting element.

A second exemplary embodiment of the invention provides a peel and stick adhesive radiant floor heating element that includes: a top surface; a thermo-resistive element coupled to the top surface and adapted to generate heat in response to an applied voltage; and an adhesive layer coupled to the thermo-resistive element.

A third exemplary embodiment of the invention provides a method of installing radiant floor heating using a peel and stick adhesive radiant floor heating element. The method includes: removing a release liner from an adhesive surface of the heating element; and securing the heating element to a sub-surface.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIGS. 1A-1C illustrate cross-section side views of radiant heating elements according to some embodiments of the invention;

FIG. 2A illustrates a top view of the radiant heating element of FIG. 1;

FIG. 2B illustrates a schematic block diagram of the radiant heating element of FIG. 1;

FIGS. 3A-3B illustrate top views of electrically conductive elements of the radiant heating element of FIG. 1;

FIGS. 4A-4B illustrate top views of electrically conductive elements of the radiant heating element of FIG. 1 that have been altered to avoid an obstacle;

FIG. 5 illustrates a top view of a conceptual connection scheme and layout using the radiant heating element of FIG. 1; and

FIG. 6 illustrates a flow chart of a conceptual process used by some embodiments to install the radiant heating element of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features. Broadly, some embodiments of the present invention generally provide an adhesive radiant flooring element.

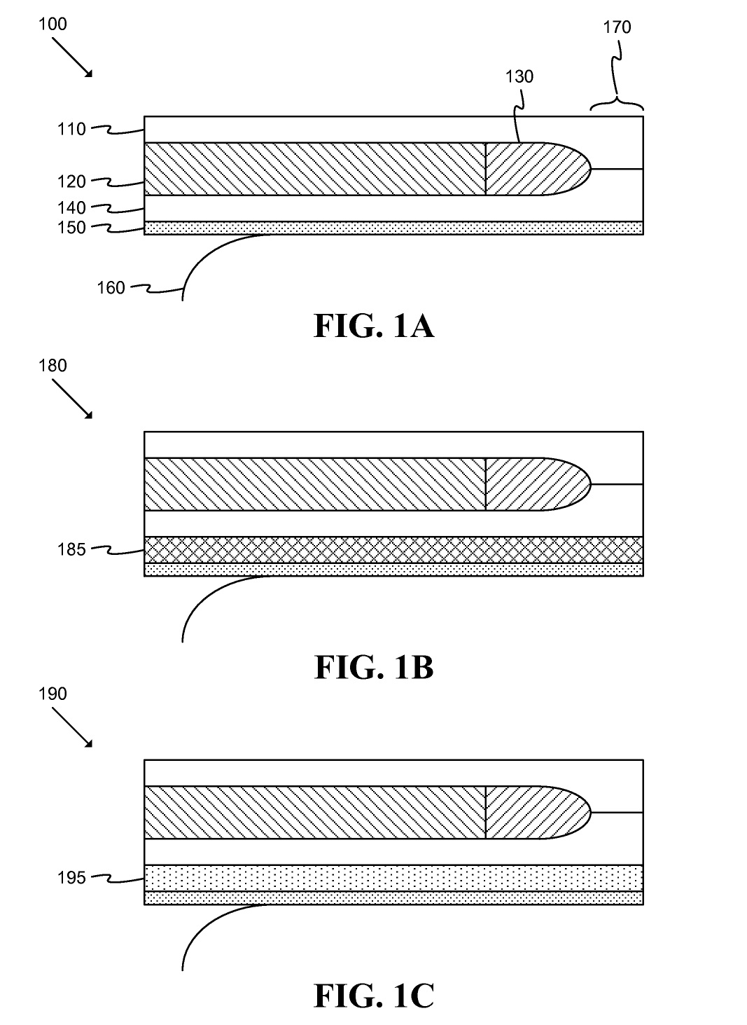

FIGS. 1A-1C illustrate cross-section side views of radiant heating elements according to some embodiments of the invention. As shown, FIG. 1A illustrates a first element 100 that may include a top layer 110, a resistive element 120, a conducting element 130, a bottom layer 140, an adhesive layer 150 with a release liner 160 and a sealed edge region 170. FIG. 1B illustrates a second element 180 that may further include a thermal barrier 185. FIG. 1C illustrates a third element 190 that may further include a sound barrier 195.

The top layer 110 may be a geotextile and/or other suitable material(s) that may allow for direct application of adhesive and/or bonding materials (e.g., thin-set mortar). In some embodiments, the top layer may be integrated with the resistive element 120. Such integration may involve combining various materials wholly or partially into a set of conceptually distinct layers that may be formed from a single physical combination of elements. Such integrated embodiments may be produced without using any adhesive (e.g., an adhesive or bonding layer) between the top layer 110 and the resistive element 120. Alternatively, the top layer 110 may be adhered to the resistive element 120 using various appropriate elements (e.g., adhesives, bonding agents, etc.).

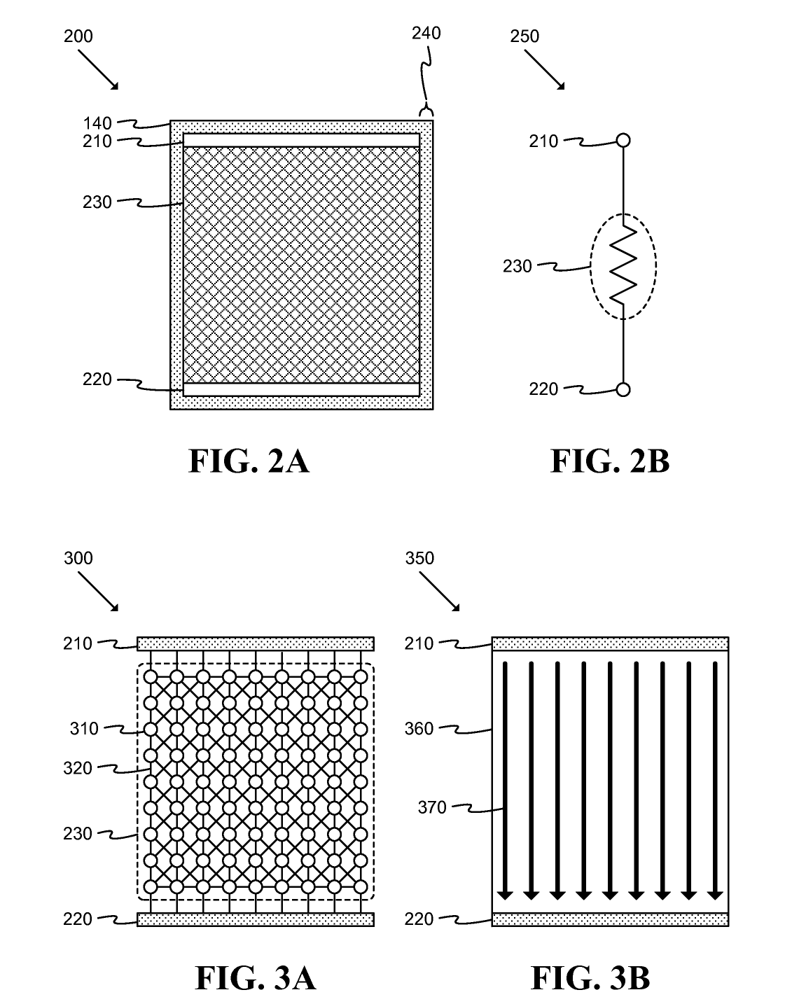

The resistive element 120 (or thermo-resistive element) may be any set of materials or elements that is able to generate heat when power is applied to the element. The resistive element will be described in more detail in reference to FIGS. 2A-3B below.

The conducting element 130 may be a metal bar or wire that is able to conduct electricity. The conducting element may be electrically coupled to the resistive element 120 in various appropriate ways (e.g., via wired connection, via solder connection, etc.). A typical heating element may include multiple conducting elements (e.g., two elements to serve as positive and negative connection points). Although the resistive element 120 and conducting elements 130 are shown as being uniform matching thickness, one of ordinary skill in the art will recognize that the elements may be different thicknesses, may be embedded within other materials (e.g., fabrics, silicon, etc.), and/or otherwise appropriately modified without departing from the spirit of the invention.

The bottom layer 140 may be a geotextile and/or other suitable material. The top layer 110 and bottom layer 140 may be formed from materials that are electrical insulators such that any current and/or voltage applied to the conducting element 130 and/or resistive element 120 may not be able to pass through the top 110 or bottom layer 140. In some embodiments, the bottom layer may be integrated with the resistive element 120 and/or the top layer 110. Such integration may be similar to that described above in reference to the top layer and the resistive element 120.

The adhesive layer 150 may be made of various appropriate materials and may be integrated with the bottom layer 140 or appropriately attached (e.g., using various adhesives, bonding agents, etc.). The release liner 160 may prevent an adhesive surface of the adhesive layer 150 from being exposed prior to installation and may allow an installer to expose the adhesive surface prior to adhering the radiant heating element to a sub-surface. The release liner 160 may be made from various appropriate materials (e.g., paper, plastic, silicon, etc.). The release liner may be “peeled” away from the adhesive layer 150 to allow the element 100 to be adhesively coupled to a sub-surface (e.g., a sub-floor, sheetrock, etc.).

The sealed edge section 170 may be formed by the top layer 110 and bottom layer 140, where the layers may be integrated or otherwise joined along the exterior edge of the heating element of some embodiments.

The thermal barrier 185 may provide thermal insulation from the resistive heat source 120 to the sub-surface. The thermal barrier 185 may be made from various appropriate materials (e.g., cork, neoprene, carpet padding, etc.). In some embodiments, the thermal barrier may be placed adjacent to different layers than shown.

The sound barrier 195 (or sound-proofing layer) may provide aural insulation and may be made from various appropriate materials. The sound barrier may be placed adjacent to different layers than shown.

In addition to the elements described above, some embodiments may include a ground layer (e.g., a wire mesh layer that extends nearly to the edges of each sheet of the radiant heating element) and/or other layers (e.g., a waterproof or water resistant layer, a top surface adhesive layer, etc.).

One of ordinary skill in the art will recognize that FIGS. 1A-1C are conceptual in nature and different embodiments may differ from the examples shown in various different ways without departing from the spirit of the invention. For instance, the absolute and/or relative thicknesses of each layer or element may be different than shown. In some embodiments, the total thickness of the element 100 may be, for example, 1-2 mm.

As another example, some embodiments may include additional layers or elements (e.g., intermediary and/or surface layers and/or elements) while some embodiments may omit some layers or elements. Different embodiments may have different dimensions for each layer and/or the thickness of a heating element. Such dimensions may be based at least partly on the number and types of layers (e.g., sound-proofing layers may have a thickness that is different than water resistant layers), materials (e.g., resistive materials, geotextile materials, etc.), application (e.g., installations where a material of a specified thickness is desired, different types of adhesive layers depending on type of sub-surface, etc.), preference, and/or other appropriate factors.

As still another example, some embodiments may combine layers into a single element (e.g., the bottom layer and thermal barrier of some embodiments may be combined to form a single layer). Furthermore, although the heating element is described as a rectangular sheet, different embodiments may provide differently shaped elements (e.g., round, triangular, hexagonal, etc.) that may be provided in various different ways (e.g., rolled about a cylindrical core). In addition, although various examples below may refer to specific embodiments of the radiant heating elements, other specific embodiments may be used in different implementations.

FIG. 2A illustrates a top view of the radiant heating element 100. In this example, the top layer 110 has been omitted for clarity. As shown, the element 100 may include a bottom layer 140 (which may have an adhesive layer 150 and release liner 160 underneath). In addition, the element 100 may include a first conducting element 210, a second conducting element 220, and a resistive element 230. The conducting elements 210-220 may be metal bars or wires as described above in reference to element 130. The resistive element 230 may be formed using various appropriate elements and/or materials as described above in reference to element 120. The heating element 100 may include an edge area 240 formed by the bottom layer 140 and top layer (not shown) that may be used to form the sealed edge region 170 described above.

FIG. 2B illustrates a schematic block diagram of the radiant heating elements of FIGS. 1A-1C. The resistive element 230 may generate heat when a voltage (and associated current) is applied across the terminals 210-220. The generated heat may be based at least partly on the applied power (e.g., the heat may be proportional to the applied power). Different embodiments may be designed to operate under various different conditions (e.g., different voltage levels, different power levels, etc.). In addition, different embodiments may be optimized to work in various different embodiments (e.g., the ratio of heat to applied power may depend on the type of flooring material, the resistance of the resistive element may be varied depending on the available power supply, etc.).

The resistive element 230 may be made at least partially from materials such as carbon ink, combinations of germanium and carbon, and/or other appropriate materials that are capable of generating heat from applied voltage/current.

FIGS. 3A-3B illustrate top views of electrically conductive elements of the radiant heating element 100.

As shown, in a first example 300, the resistive element 230 may be formed by a combination of resistive sub-elements 310 and connecting elements 320. Different embodiments may include different numbers of sub-elements 310 and/or connecting elements 320 that may be arranged and/or connected in various different ways. For instance, in different embodiments each sub-element 310 may be formed using different shapes (e.g., ellipses, polygons such as rectangles, hexagons, octagons, etc.). The sub-elements may be formed from any materials capable of generating heat when power is applied. The connecting elements 320 may be made from metal and/or other appropriate materials and may form a pathway between the connection terminals 210-220 such that current is able to flow across the resistive element 230.

In a second example 350, the resistive element 230 is formed by a resistive sheet 360. In this example, conceptual current pathways 370 are illustrated. One of ordinary skill in the art will recognize that current may be able to flow across the sheet 360 (and/or portions of the sheer) in various different directions along multiple pathways within the resistive material that forms the sheet 360. Such a resistive sheet may be formed using various appropriate materials that may allow current to flow across the sheet while generating a thermal output based on the applied power.

One of ordinary skill in the art will recognize that the elements described above in reference to FIGS. 3A-3B are conceptual in nature and may be implemented in various different ways without departing from the spirit of the invention. For instance, different embodiments may include differently shaped resistive sub-elements. As another example, different embodiments may include different arrangements of sub-elements.

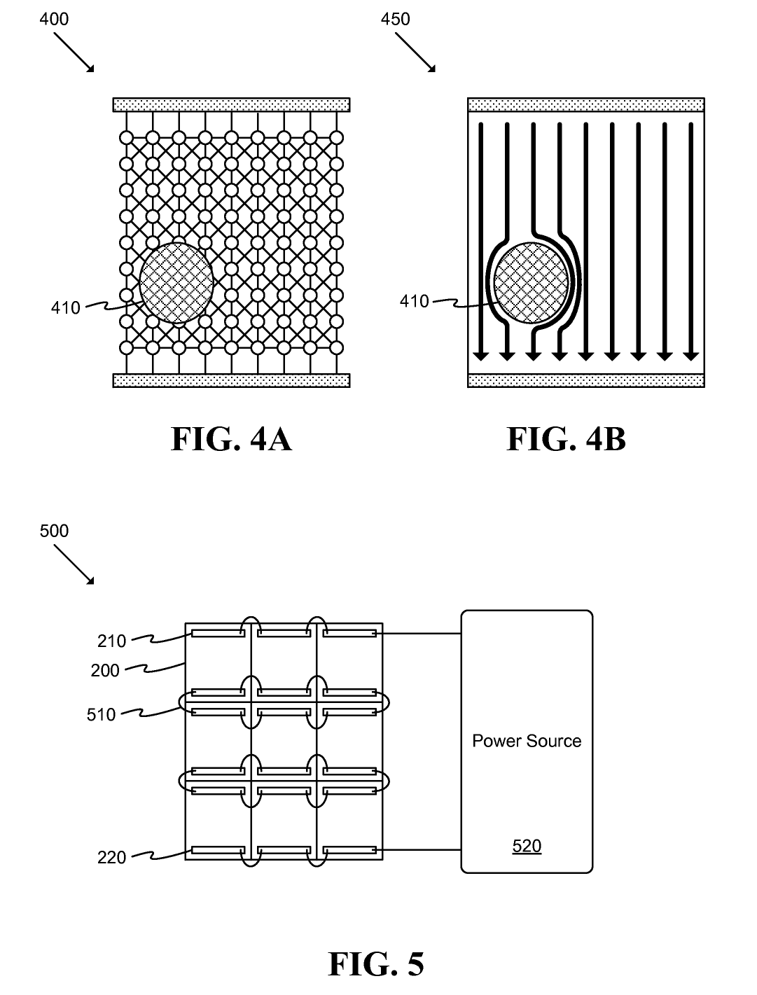

FIGS. 4A-4B illustrate top views of electrically conductive elements of the radiant heating element 100 that have been altered to avoid an obstacle.

In a first example 400, the obstacle is an ellipse 410. In this example, the various sub-elements 310 and connectors 320 may provide pathways around the obstacle 410. Although the overall resistance of the element 400 may be increased due to the reduction in parallel paths, the change may be insignificant. Some embodiments may specify a maximum area that may be able to be removed from each sheet without affecting performance beyond a certain threshold.

In a second example 450, the sheet material allows various current paths to be formed around the obstacle 410 as shown. As above, some embodiments may specify a maximum area that may be able to be removed.

In some embodiments, the radiant heating element 100 may be able to be trimmed at each end (i.e., the sides of the rectangular element formed parallel to connective elements 210 and 220). Such trimming may allow, for example, end cuts with an angle up to forty-five degrees. Some embodiments may provide various pathways (which may be marked using various appropriate graphic elements on an outside surface of the element 100) that are spaced at regular intervals (e.g., eight inches) to allow an installer to trim the element at each interval.

Different embodiments may allow different modifications (e.g., angular cuts, circular cuts, trimming of sheets for size, etc.). In some embodiments, the connectors 210-220 may also be able to trimmed, cut, and/or otherwise modified.

FIG. 5 illustrates a top view of a conceptual connection scheme and layout 500 using the radiant heating element 100. In this example, there are no obstacles and the area is a rectangle that allows full sheet of radiant heating elements to be used. As shown, the connection terminals 210-220 of each heating element may be coupled to other connection terminals via connection elements 510. Such connection elements may include wires, solder, connectors, and/or other appropriate ways of forming electrical connections among the elements. For instance, in some embodiments at least one exterior layer of the heating element 100 may be cut and peeled back to expose a connection element 510. As another example, various clamps may pierce any non-conductive layers of the element 100 to reach one or more connection terminals 210-220.

In some embodiments, each radiant heating element may include connectors (e.g., exposed wires, terminals, sockets, etc.) that may be coupled to other heating elements (or external elements). Alternatively, installers may be required to attached connectors (e.g., by cutting through the top layer to expose the connection terminals, by clamping a connecting element across the outer surfaces of the heating element, etc.).

As shown, the heating region 500 formed by the elements 200 may be powered by a power source 520. Such a power source may include various electrical components and/or connections that are able to provide the appropriate voltage and/or current to the matrix 500 of elements 200.

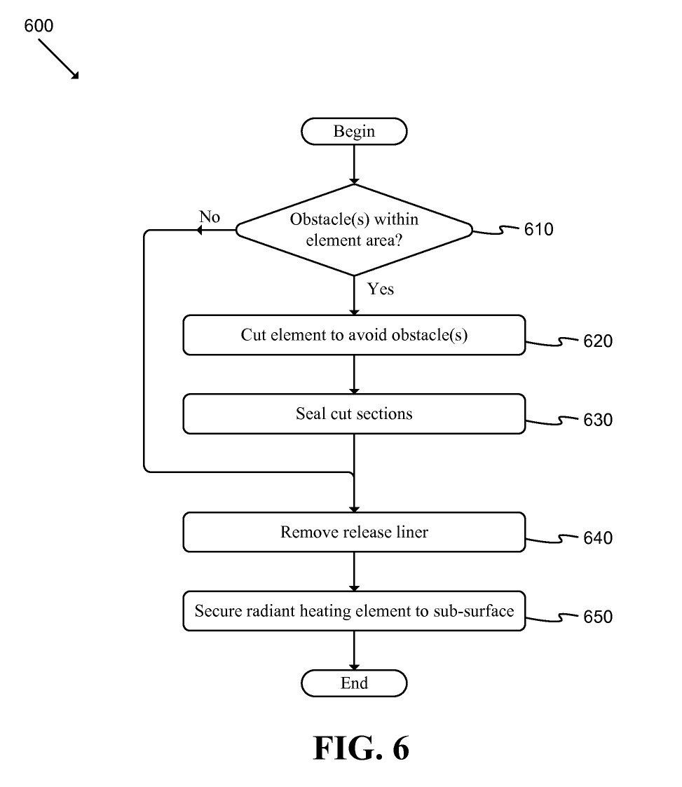

FIG. 6 illustrates a flow chart of a conceptual process 600 used by some embodiments to install the radiant heating element of FIG. 1. Such a process may begin, for instance, when an installer retrieves a heating element of some embodiments. Next the process may determine (at 610) whether there are obstacles within the element area (i.e., the area to be covered by an element when installed). The process may then cut (at 620) the element to avoid the obstacles (e.g., by using scissors, a knife, etc. to cut a hole or other portal through the heating element). The process may then seal (at 630) the cut sections. Such sealing may involve placing insulating tape around the cut section such that the conducting elements are isolated from external elements. Alternatively, such cuts may be sealed using various compounds (e.g., silicon gels, caulk, etc.) that are not electrically conductive (and/or otherwise appropriately sealed).

Next, or after determining (at 610) that there are no obstacles within the element area, the process may remove (at 640) the release liner (e.g., by peeling away a paper layer), secure (at 650) the radiant heating element to the sub-surface, and then end.

In addition, the installation process may involve coupling each heating element to one or more other elements and/or to a power source.

After installing all the elements in a zone or area, the installer may apply thin-set mortar or other appropriate materials and then install a finish surface (e.g., wood flooring, tile, etc.).

One of ordinary skill in the art will recognize that while process 600 has been described with reference to various specific details, the process may be implemented in various different ways without departing from the spirit of the invention. For instance, different embodiments may perform the operations in a different order, include additional operations, omit operations, and/or otherwise change the process as appropriate.

It should be understood, of course, that the foregoing relates to illustrative details of exemplary embodiments of the invention and that modifications may be made without departing from the spirit and scope of the invention as defined by the following claims.

I claim:

1. A radiant heating element comprising:
a top layer;
a resistive element coupled to the top layer;
a conducting element coupled to the resistive layer and the top layer; and
a bottom layer coupled to the resistive layer and the conducting element.

2. The radiant heating element of claim 1 further comprising an adhesive layer coupled to the bottom layer.

3. The radiant heating element of claim 2 further comprising a release liner coupled to the adhesive layer.

4. The radiant heating element of claim 1, wherein the top layer and the bottom layer comprise geotextile.

5. The radiant heating element of claim 1 further comprising a thermal barrier coupled to the bottom layer.

6. The radiant heating element of claim 1 further comprising a sound barrier coupled to the bottom layer.

7. The radiant heating element of claim 1, wherein the resistive element comprises a plurality of resistive sub-elements electrically coupled by a plurality of connectors.

8. A peel and stick adhesive radiant floor heating element comprising:
a top surface;
a thermo-resistive element coupled to the top surface and adapted to generate heat in response to an applied voltage; and
an adhesive layer coupled to the thermo-resistive element.

9. The peel and stick adhesive radiant floor heating element of claim 8 further comprising a pair of conducting elements, each conducting element electrically coupled to the thermo-resistive element.

10. The peel and stick adhesive radiant floor heating element of claim 8 further comprising a release liner coupled to an exterior surface of the adhesive layer.

11. The peel and stick adhesive radiant floor heating element of claim 8, wherein the thermo-resistive element is adapted to allow arbitrarily-shaped ports to be cut into the resistive element.

12. The peel and stick adhesive radiant floor heating element of claim 8, wherein the element has a thickness of 1-2 mm.

13. The peel and stick adhesive radiant floor heating element of claim 8 further comprising at least one waterproof layer coupled to the top surface or the adhesive layer.

14. The peel and stick adhesive radiant floor heating element of claim 8 further comprising at least one soundproofing layer.

15. A method of installing radiant floor heating using a peel and stick adhesive radiant floor heating element, the method comprising:
removing a release liner from an adhesive surface of the heating element; and
securing the heating element to a sub-surface.

16. The method of claim 15 further comprising:
creating a set of ports within the heating element; and
sealing edges of each port within the set of ports using an insulating element.

17. The method of claim 15 further comprising trimming the heating element at one or more arbitrary locations.

18. The method of claim 15 further comprising electrically connecting at least one connective element from a set of connective elements from the heating element to one or more other heating elements.

19. The method of claim 18 further comprising electrically connecting at least one connective element from a set of connective elements from the heating element to a power supply.

20. The method of claim 15 wherein the heating element comprises a resistive layer comprising at least one of carbon ink and a combination of germanium and carbon.
